(19) United States
(12) Patent Application Publication
(10) Pub. No.: US 2007/0204470 A1
(43) Pub. Date: Sep. 6, 2007

(54) MULTI-LAYERED CUTTING DEVICE

(76) Inventor: Mu-Tung Lai, Taichung (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/308,032

(22) Filed: Mar. 3, 2006

(51) Int. Cl. B26B 13/00

(52) U.S. Cl. 30/244

(57) ABSTRACT

A cutting device includes a first handle, a second handle pivotally connected to the first handle, a knife attached to the first handle and an anvil attached to the second handle. The anvil includes an intermediate member and two lateral members connected to each other by the intermediate member. Each of the lateral members includes a first beam and a second beam. Defined between the lateral members is a space for receiving the knife.

### BACKGROUND OF INVENTION

1. Field of Invention

The present invention relates to a multi-layered cutting device.

2. Related Prior Art

Referring to FIGS. 11 and 12, there is shown a conventional cutting device including a first handle 1, a second handle 2 pivotally connected to the first handle 1, a knife 3 attached to the second handle 2 and an anvil 5 attached to the first handle 1. The anvil 5 defines a groove 6 for receiving the knife 3. A user can cut a string, a rod and a strip with the cutting device. However, a user cannot do a clear cut of a trough-shaped object 9 with the cutting device because the object 9 will inevitably be moved and deformed.

The present invention is therefore intended to obviate or at least alleviate the problems encountered in prior art.

### SUMMARY OF INVENTION

According to the present invention, a cutting device includes a first handle, a second handle pivotally connected to the first handle, a knife attached to the first handle and an anvil attached to the second handle. The anvil includes an intermediate member and two lateral members connected to each other by the intermediate member. Each of the lateral members includes a first beam and a second beam. Defined between the lateral members is a space for receiving the knife.

An advantage of the cutting device of the present invention is that it enables a user to do a clear cut of a trough-shaped object.

Another advantage of the cutting device of the present invention is that it enables a user to conduct a stable cutting operation since the space receives the knife and the lateral members of the anvil guide the knife.

Other advantages and features of the present invention will become apparent from the following description referring to the drawings.

### BRIEF DESCRIPTION OF DRAWINGS

The present invention will be described through detailed illustration of two embodiments referring to the drawings.

FIG. 1 is a perspective view of a multi-layered cutting device according to the first embodiment of the present invention.

FIG. 2 is a perspective view of the cutting device in another position than shown in FIG. 1.

FIG. 3 is an exploded view of the cutting device shown in FIG. 2.

FIG. 4 is a side view of a trough-shaped object being cut by the cutting device shown in FIG. 2.

FIG. 5 is a side view of the object and the cutting device in another position than shown in FIG. 4.

FIG. 6 is a side view of the object and the cutting device in another position than shown in FIG. 5.

FIG. 7 is a side view of the object and the cutting device in another position than shown in FIG. 6.

FIG. 8 is a front view of the object and the cutting device shown in FIG. 5.

FIG. 9 is a side view of another trough-shaped object being cut by the cutting device shown in FIG. 2.

FIG. 10 is a perspective view of a multi-layered cutting device according to the second embodiment of the present invention.

FIG. 11 is a perspective view of a conventional cutting device.

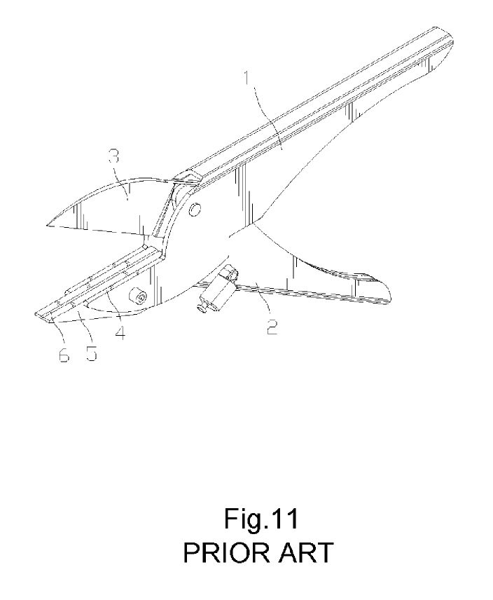

FIG. 12 is a side view of a trough-shaped object being cut by the cutting device shown in FIG. 11.

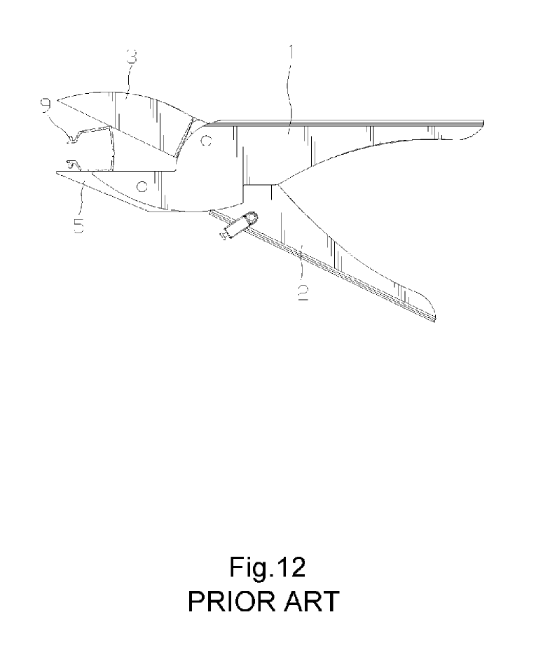

### DETAILED DESCRIPTION OF EMBODIMENTS

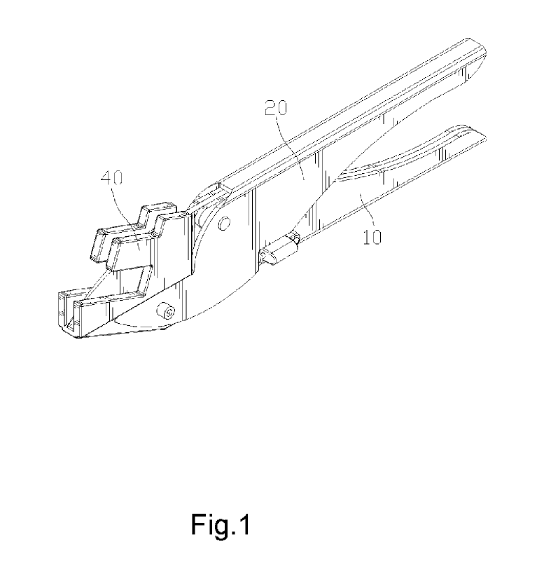

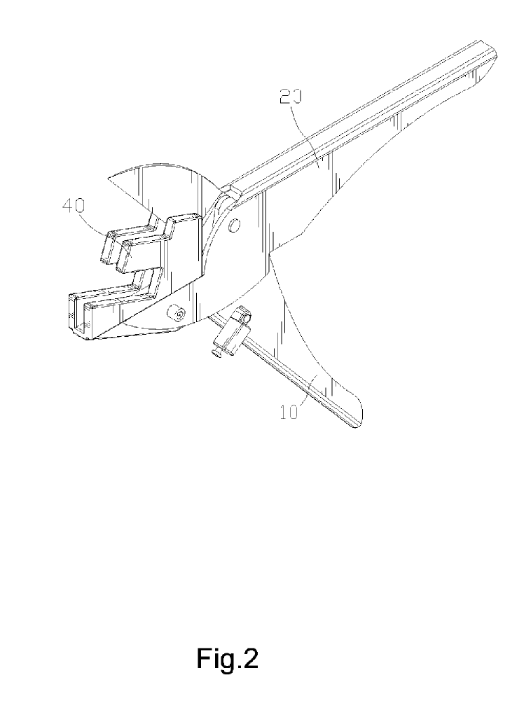

Referring to FIGS. 1 and 2, there is a multi-layered cutting device according to a first embodiment of the present invention. The cutting device includes a first handle 10 and a second handle 20 pivotally connected to the first handle 10.

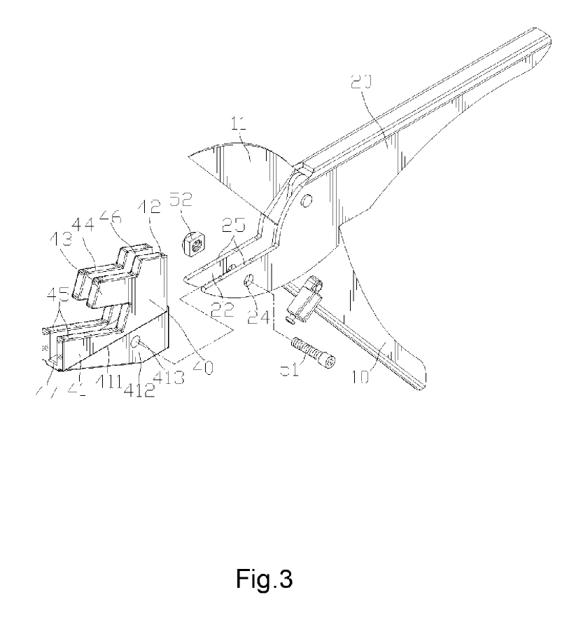

Referring to FIG. 3, the cutting device includes a knife 11 connected to the first handle 10 and a multi-layered anvil 40 connected to the second handle 20. The first handle 10 is located between two lateral members 22 of the second handle 20. Each of the lateral members 22 of the second handle 20 includes an upper edge 25 and an aperture 24 therein.

The anvil 40 includes two lateral members 42 and an intermediate member 412 formed for interconnecting the lateral members 42, with a space 46 between the lateral members 42. Each of the lateral members 42 of the anvil 40 includes a lower edge 411, a first beam 43 and a second beam 41. The first beam 43 includes an upper edge 44. The second beam 41 includes an upper edge 44. The intermediate member 412 of the anvil 40 includes an upper edge 47. The intermediate member 412 of the anvil 40 defines an aperture 413.

The intermediate member 412 of the anvil 40 is positioned between the lateral members 22 of the second handle 20. The lower edges 411 of the lateral members 42 of the anvil 40 are installed on the upper edges 25 of the lateral members of the second handle 20. The anvil 40 is attached to second handle 20 by a fastening device. The fastening device includes a threaded bolt 51 inserted through the apertures 24 of the second handle 20 and the aperture 413 of the anvil 40 and a nut 52 engaged with the threaded bolt 51.

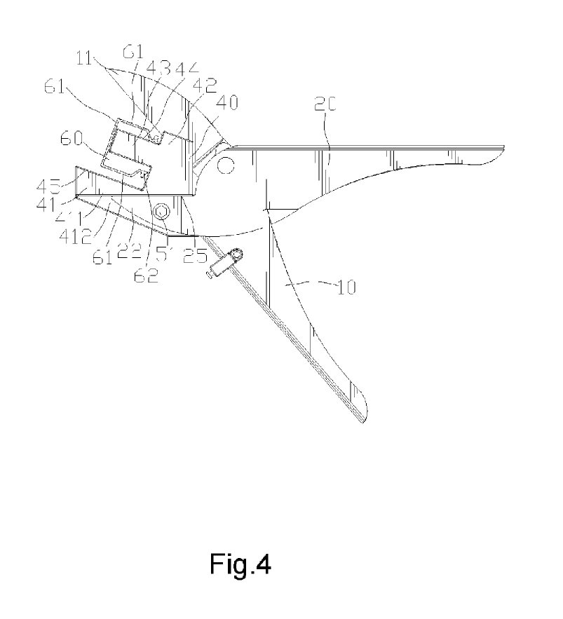

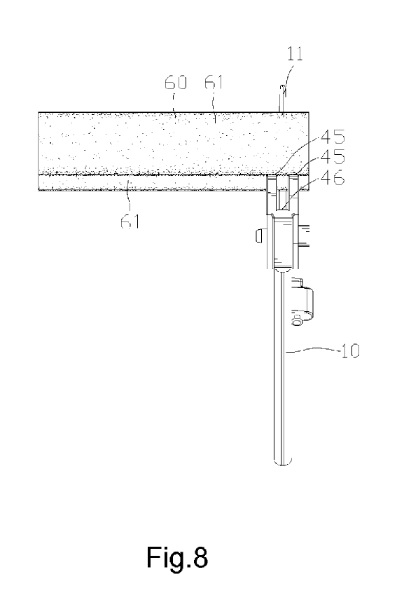

Referring to FIGS. 4 and 8, there is shown a trough-shaped object 60 including a first lateral member 61, a second lateral member 61 and an intermediate member 61 formed between the first and second lateral members 61. The object 60 is positioned on the first beams 43 of the lateral members 42 of the anvil 40.

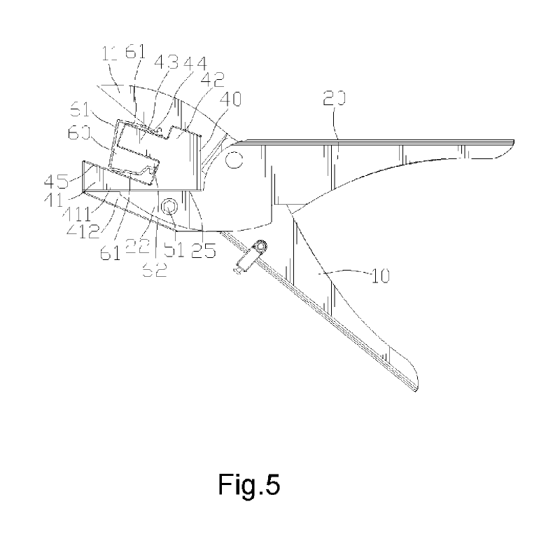

Referring to FIG. 5, when the knife 11 cuts the first lateral member 61 of the object 60, the first lateral member 61 of the object 60 is supported on the first beams 43 of the lateral members 42 of the anvil 40 while the second lateral member 61 of the object 60 is supported on the second beams 41 of the lateral members 42 of the anvil 40. The object 60 is not moved or deformed.

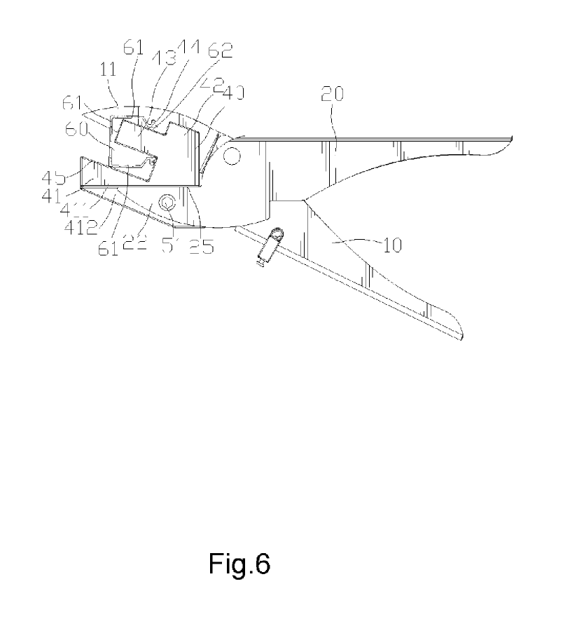

Referring to FIG. 6, when the knife 11 cuts the intermediate member 61 of the object 60, the first lateral member 61 of the object 60 is still supported on the first beams 43 of the lateral members 42 of the anvil 40 while the second lateral member 61 of the object 60 is supported on the second beams 41 of the lateral members 42 of the anvil 40. The object 60 is not moved or deformed.

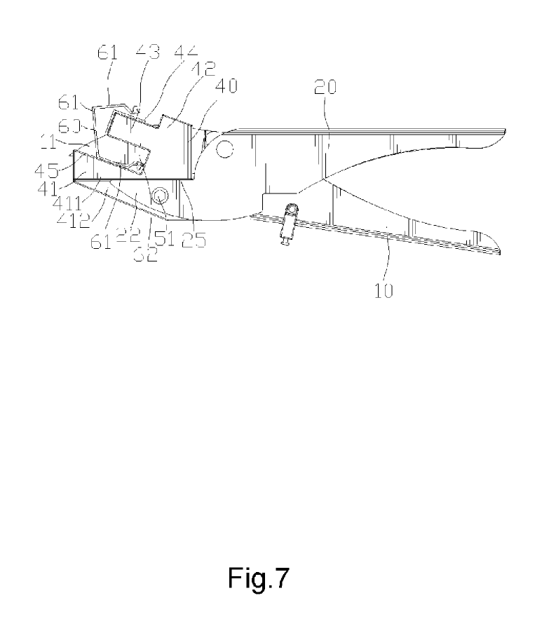

Referring to FIG. 7, when the knife 11 cuts the second lateral member 61 of the object 60, the first lateral member 61 of the object 60 is moved from the first beams 43 of the lateral members 42 of the anvil 40 while the second lateral member 61 of the object 60 is still supported on the second beams 41 of the lateral members 42 of the anvil 40. The object 60 is not moved. The object 60 is deformed; it however does not interfere with the knife 11.

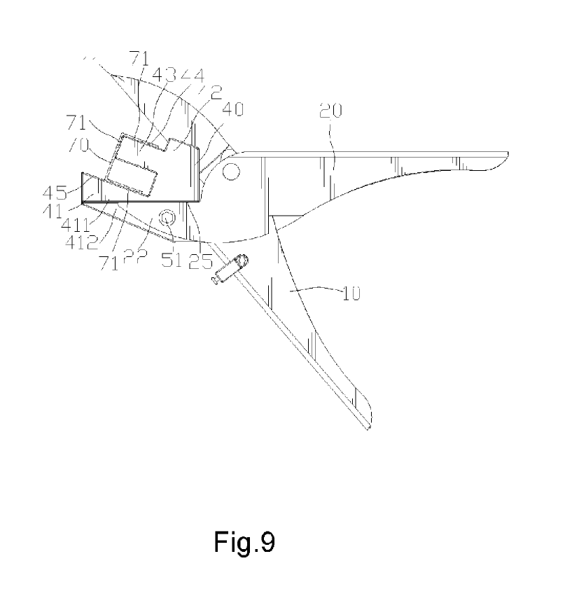

Referring to FIG. 9, another trough-shaped object 70 is cut by the cutting device. The trough-shaped object 70 includes a first lateral member 71, a second lateral member 71 and an intermediate member 71 formed between the first and second lateral members 71. The object 70 is positioned on the first beams 43 of the lateral members 42 of the anvil 40. The first lateral member 71 of the object 70 is in tight contact with the first beams 43 of the lateral members 42 of the anvil 40 while the second lateral member 71 of the object 70 is in tight contact with the second beams 41 of the lateral members 42 of the anvil 40.

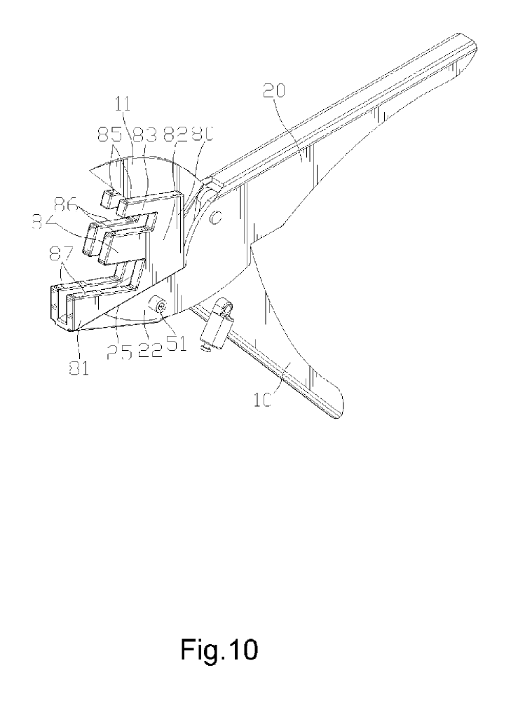

Referring to FIG. 10, there is shown a cutting device according to a second embodiment of the present invention. The second embodiment is similar to the first embodiment except including an anvil 80 instead of the anvil 40. The anvil 80 is similar to the anvil 40 except including two lateral members 82 including a first beam 83, a second beam 84 and a third beam 81. The first beam 83 includes an upper edge 85. The second beam includes an upper edge 86. The third beam 81 includes an upper edge 87.

The cutting device of the present invention exhibits at least three advantages. Firstly, it enables a user to do a clear cut of a trough-shaped object. Secondly, it enables a user to do clear cuts of trough-shaped objects of various sizes since each of the lateral members of the anvil includes three beams. Thirdly, enables a user to conduct a stable cutting operation since the space receives the knife and the lateral members of the anvil guide the knife.

The present invention has been described through the illustration of the embodiments. Those skilled in the art can derive variations from the embodiments without departing from the scope of the present invention. Hence, the embodiments shall not limit the scope of the present invention defined in the claims.

What is claimed is:

1. A cutting device comprising:
a first handle;
a second handle pivotally connected to the first handle;
a knife attached to the first handle; and
an anvil attached to the second handle, the anvil comprises an intermediate member and two lateral members connected to each other by the intermediate member and each formed with a first beam and a second beam, wherein defined between the lateral members is a space for receiving the knife.

2. The cutting device according to claim 1 wherein the second handle comprises two lateral members between which the intermediate member of the anvil is positioned.

3. The cutting device according to claim 2 wherein each of the lateral members of the second handle defines an aperture, wherein the intermediate member of the anvil defines an aperture for receiving a fastener driven through the apertures of lateral members of the second handle.

4. The cutting device according to claim 2 wherein the lateral members of the anvil are installed on the lateral members of the second handle.

5. The cutting device according to claim 4 wherein the each of lateral members of the anvil comprises an edge, wherein the each of the lateral members of the second handle comprises an edge for supporting the edge of related one of the lateral members of the anvil.

6. The cutting device according to claim 1 wherein the first beam comprises an edge for contact with an external object to be cut by the cutting device.

7. The cutting device according to claim 1 wherein the second beam comprises an edge for contact with an external object to be cut by the cutting device.

8. The cutting device according to claim 1 wherein each of the lateral members of the anvil comprises a third beam formed next to the second beam.

9. The cutting device according to claim 8 wherein the first beam comprises an edge for contact with an external object to be cut by the cutting device.

10. The cutting device according to claim 8 wherein the first beam comprises an edge for contact with an external object to be cut by the cutting device.

11. The cutting device according to claim 8 wherein the first beam comprises an edge for contact with an external object to be cut by the cutting device.
